(19) United States
(12) Patent Application Publication
(10) Pub. No.: US 2026/0280436 A1
(43) Pub. Date: Sep. 17, 2026

(54) ELECTRIC POWER CONVERSION APPARATUS

(71) Applicant: TDK Corporation, Tokyo (JP)

(72) Inventor: Ryosuke Ushikubo, Tokyo (JP)

(73) Assignee: TDK Corporation, Tokyo (JP)

(21) Appl. No.: 19/450,915

(22) Filed: Jan. 16, 2026

(30) Foreign Application Priority Data
Mar. 14, 2025 (JP) 2025-040950

(51) Int. Cl. H02M 3/335; H02M 3/00

(52) U.S. Cl. CPC H02M 3/33576; H02M 3/01

(57) ABSTRACT

An electric power conversion apparatus includes: two input terminals; two output terminals; a transformer; an inverter circuit including first and second main switches and first and second clamp switches, a clamp capacitor, and first and second coupling lines; a rectifying circuit; a smoothing circuit; and a control circuit. In the inverter circuit, the first main switch and the first clamp switch are disposed on the first coupling line in series and in this order; the second main switch and the second clamp switch are disposed on the second coupling line in series and in an order reverse to that on the first coupling line; and the clamp capacitor is disposed on a first or second end side of the first clamp switch on the first coupling line, or disposed on a first or second end side of the second clamp switch on the second coupling line.

### CROSS-REFERENCE TO RELATED APPLICATIONS

The present application claims priority from Japanese Patent Application No. 2025-040950 filed on Mar. 14, 2025, the entire contents of which are hereby incorporated by reference.

### BACKGROUND

The disclosure relates to an electric power conversion apparatus that converts electric power through the use of a switching device.

Various types of electric power conversion apparatuses or switching power supply apparatuses, including DC-to-DC converters, have been proposed. For example, Japanese Unexamined Patent Application Publication No. 2020-202679 discloses an electric power conversion apparatus including an active clamp forward circuit.

### SUMMARY

An electric power conversion apparatus according to one embodiment of the disclosure includes a pair of input terminals, a pair of output terminals, a transformer, an inverter circuit, a rectifying circuit, a smoothing circuit, and a control circuit. The pair of input terminals are configured to receive an input voltage. The pair of output terminals are configured to output an output voltage. The transformer includes a primary winding and a secondary winding. The inverter circuit is disposed between the pair of input terminals and the primary winding, and includes switching devices, a clamp capacitor, a first coupling line, and a second coupling line. The switching devices include a first main switch, a second main switch, a first clamp switch, and a second clamp switch. The first coupling line and the second coupling line are disposed in parallel to each other between the pair of input terminals. The rectifying circuit is disposed between the pair of output terminals and the secondary winding, and includes rectifiers. The smoothing circuit is disposed between the pair of output terminals and the rectifying circuit, and includes a choke coil and a capacitor. The control circuit is configured to perform switching driving to control respective operations of the switching devices. In the inverter circuit, the first main switch and the first clamp switch are disposed on the first coupling line in series to each other and in this order; the second main switch and the second clamp switch are disposed on the second coupling line in series to each other and in an order reverse to the order in which the first main switch and the first clamp switch are disposed on the first coupling line; and the clamp capacitor is disposed on a first end side or a second end side of the first clamp switch on the first coupling line, or disposed on a first end side or a second end side of the second clamp switch on the second coupling line.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a circuit diagram illustrating a schematic configuration example of an electric power conversion apparatus according to one example embodiment of the disclosure.

FIG. 2 is a timing chart illustrating an example operation during switching driving according to the example embodiment.

FIG. 3 is a circuit diagram illustrating an operation state during a time period T1 in FIG. 2.

FIG. 4 is a circuit diagram illustrating an operation state during a time period T2 in FIG. 2.

FIG. 5 is a circuit diagram illustrating an operation state during a time period T3 in FIG. 2.

FIG. 6 is a circuit diagram illustrating an operation state during a time period T41 in FIG. 2.

FIG. 7 is a circuit diagram illustrating an operation state during a time period T42 in FIG. 2.

FIG. 8 illustrates an example of corresponding relationships between a direct-current input voltage and voltages applied to switching devices in the example embodiment.

FIG. 9 is a circuit diagram illustrating a schematic configuration example of an electric power conversion apparatus according to Comparative Example 1.

FIG. 10 illustrates an example of corresponding relationships between the direct-current input voltage and voltages applied to switching devices in Comparative Example 1.

FIG. 11 is a timing chart illustrating an example of temporal changes of a DC component and a ripple component in Comparative Example 1.

FIG. 12 is a timing chart illustrating an example of temporal changes of multiple kinds of voltages and a current in the example embodiment.

FIG. 13 illustrates an example of a corresponding relationship between the direct-current input voltage and a clamp voltage in each of Example 1 and Comparative Example 1.

FIG. 14 illustrates an example of a DC bias characteristic of a clamp capacitor of the example embodiment.

FIG. 15 is a circuit diagram illustrating a schematic configuration example of an electric power conversion apparatus according to Modification Example 1.

FIG. 16 is a circuit diagram illustrating a schematic configuration example of an electric power conversion apparatus according to Modification Example 2.

FIG. 17 is a timing chart illustrating an example of temporal changes of multiple kinds of voltages in Example 2.

FIG. 18 is a timing chart illustrating an example of temporal changes of multiple kinds of voltages in Modification Example 2.

FIG. 19 is a circuit diagram illustrating a configuration example of a current detection circuit and a control circuit of an electric power conversion apparatus according to Modification Example 3.

FIG. 20 is a circuit diagram illustrating a configuration example of a current detection circuit and a control circuit of an electric power conversion apparatus according to Comparative Example 2.

FIG. 21 is a timing chart illustrating an example operation during a current detection operation in Comparative Example 2.

FIG. 22 is a timing chart illustrating an example operation during the current detection operation in Modification Example 3.

FIG. 23 is a timing chart illustrating an example operation during the current detection operation in Modification Example 3-1.

FIG. 24 is a timing chart illustrating an example operation during the current detection operation in Modification Example 3-2.

FIG. 25 is a circuit diagram illustrating a schematic configuration example of an inverter circuit according to the example embodiment.

FIG. 26 is a circuit diagram illustrating a schematic configuration example of an inverter circuit according to Modification Example 4-1.

FIG. 27 is a circuit diagram illustrating a schematic configuration example of an inverter circuit according to Modification Example 4-2.

FIG. 28 is a circuit diagram illustrating a schematic configuration example of an inverter circuit according to Modification Example 4-3.

### DETAILED DESCRIPTION

Cost reduction is desired of an apparatus such as an electric power conversion apparatus.

It is desirable to provide an electric power conversion apparatus that makes it possible to achieve cost reduction.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Note that the description is given in the following order.
1. Example Embodiment: Basic configuration example
2. Modification Examples
   Modification Example 1: Configuration example with addition of a resonant coil
   Modification Example 2: Configuration example with addition of two clamp diodes
   Modification Examples 3, 3-1, and 3-2: Configuration examples each with addition of a current detection circuit including a synchronous switch
   Modification Examples 4-1 to 4-3: Other configuration examples of an inverter circuit
3. Other Modification Examples
<1. Example Embodiment>
<Configuration>

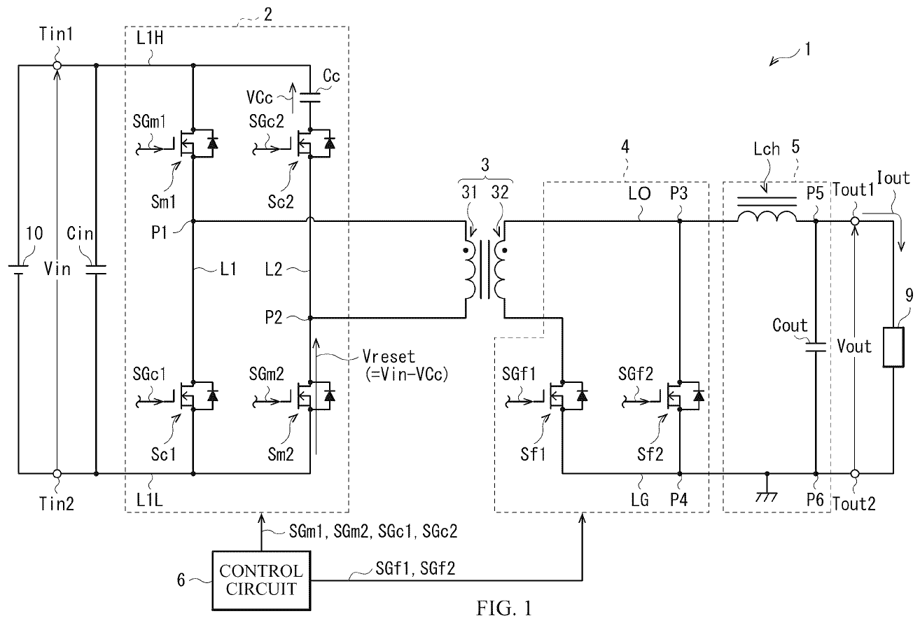

FIG. 1 is a circuit diagram illustrating a schematic configuration example of an electric power conversion apparatus 1 according to an example embodiment of the disclosure.

The electric power conversion apparatus 1 may serve as a DC-to-DC converter that performs a voltage conversion on a direct-current input voltage Vin supplied from a direct-current input power supply 10, such as a battery, into a direct-current output voltage Vout and supplies electric power to a load 9.

Non-limiting examples of the load 9 may include electronic equipment and a battery. The electric power conversion apparatus 1 may perform either an up conversion, i.e., a step-up conversion, or a down conversion, i.e., a step-down conversion, as a way of the voltage conversion.

The direct-current input voltage Vin may correspond to a specific but non-limiting example of an “input voltage” in one embodiment of the disclosure. The direct-current output voltage Vout may correspond to a specific but non-limiting example of an “output voltage” in one embodiment of the disclosure.

The electric power conversion apparatus 1 includes a pair of input terminals Tin1 and Tin2, a pair of output terminals Tout1 and Tout2, an inverter circuit 2, a transformer 3, a rectifying circuit 4, a smoothing circuit 5, and a control circuit 6. The direct-current input voltage Vin may be inputted to between the input terminals Tin1 and Tin2. The direct-current output voltage Vout may be outputted from between the output terminals Tout1 and Tout2.

The input terminals Tin1 and Tin2 may correspond to a specific but non-limiting example of a “pair of input terminals” in one embodiment of the disclosure. The output terminals Tout1 and Tout2 may correspond to a specific but non-limiting example of a “pair of output terminals” in one embodiment of the disclosure. The input terminal Tin1 may correspond to a specific but non-limiting example of a “first input terminal” in one embodiment of the disclosure. The input terminal Tin2 may correspond to a specific but non-limiting example of a “second input terminal” in one embodiment of the disclosure.

As illustrated in FIG. 1, an input smoothing capacitor Cin may be disposed between a primary high voltage line L1H coupled to the input terminal Tin1 and a primary low voltage line L1L coupled to the input terminal Tin2. The input smoothing capacitor Cin may be adapted to smooth the direct-current input voltage Vin.

### <A. Inverter Circuit 2>

As illustrated in FIG. 1, the inverter circuit 2 is disposed between the input terminals Tin1 and Tin2 and a primary winding 31 of the transformer 3. The primary winding 31 will be described later. The inverter circuit 2 includes switching devices, a clamp capacitor Cc, and two coupling lines L1 and L2. The switching devices may be four switching devices including two main switches Sm1 and Sm2 and two clamp switches Sc1 and Sc2. As described below, the inverter circuit 2 may be what is called a “full-bridge” inverter circuit.

The main switches Sm1 and Sm2 and the clamp switches Sc1 and Sc2 may correspond to a specific but non-limiting example of “switching devices” in one embodiment of the disclosure. The main switch Sm1 may correspond to a specific but non-limiting example of a “first main switch” in one embodiment of the disclosure. The main switch Sm2 may correspond to a specific but non-limiting example of a “second main switch” in one embodiment of the disclosure. The clamp switch Sc1 may correspond to a specific but non-limiting example of a “first clamp switch” in one embodiment of the disclosure. The clamp switch Sc2 may correspond to a specific but non-limiting example of a “second clamp switch” in one embodiment of the disclosure. The coupling line L1 may correspond to a specific but non-limiting example of a “first coupling line” in one embodiment of the disclosure. The coupling line L2 may correspond to a specific but non-limiting example of a “second coupling line” in one embodiment of the disclosure.

As the main switches Sm1 and Sm2 and the clamp switches Sc1 and Sc2, for example, any of various type of switching devices including, without limitation, field-effect transistors including metal-oxide-semiconductor field-effect transistors (MOS-FETs), insulated gate bipolar transistors (IGBTs), and high electron mobility transistors (HEMTs), i.e., heterostructure field-effect transistors (HFETs), may be used. Non-limiting examples of the HEMTs may include a gallium nitride (GaN) transistor.

In the example embodiment illustrated in FIG. 1, the main switches Sm1 and Sm2 and the clamp switches Sc1 and Sc2 may each include a transistor configured by a MOS-FET or a HEMT. When the MOS-FETs or the HEMTs are used as the switches, respective diodes to be coupled in parallel to the switches, as illustrated in FIG. 1, may be configured by respective parasitic diodes of the MOS-FETs or the HEMTs.

In the inverter circuit 2, the two coupling lines L1 and L2 may be disposed in parallel to each other between the input terminals Tin1 and Tin2, that is, between the primary high voltage line L1H and the primary low voltage line L1L. Further, the main switch Sm1 and the clamp switch Sc1 are disposed on the coupling line L1 in series to each other and in this order. For example, the main switch Sm1 may be disposed between the primary high voltage line L1H and a node P1, and the clamp switch Sc1 may be disposed between the node P1 and the primary low voltage line L1L. On the coupling line L2, the main switch Sm2 and the clamp switch Sc2 are disposed in series to each other and in an order reverse to the order in which the main switch Sm1 and the clamp switch Sc1 are disposed on the coupling line L1. For example, the clamp switch Sc2 may be disposed between the primary high voltage line L1H and a node P2, with the clamp capacitor Cc interposed between the clamp switch Sc2 and either the primary high voltage line L1H or the node P2, and the main switch Sm2 may be disposed between the node P2 and the primary low voltage line L1L. In the example embodiment illustrated in FIG. 1, the clamp capacitor Cc may be disposed on a first end side of the clamp switch Sc2, that is, between the clamp switch Sc2 and the primary high voltage line L1H, on the coupling line L2.

In this way, in the inverter circuit 2, a first series coupling structure, or a first arm, in which the main switch Sm1 and the clamp switch Sc1 are coupled in series to each other and a second series coupling structure, or a second arm, in which the clamp switch Sc2 and the main switch Sm2 are coupled in series to each other may be disposed in parallel to each other between the primary high voltage line L1H and the primary low voltage line L1L.

Further, in the inverter circuit 2, switching operations, i.e., ON and OFF operations, of the main switches Sm1 and Sm2 and the clamp switches Sc1 and Sc2 may be controlled in accordance with driving signals SGm1, SGm2, SGc1, and SGc2 supplied from the control circuit 6 to be described later. As a result, the direct-current input voltage Vin applied to between the input terminals Tin1 and Tin2 may be converted into an alternating-current voltage, and the alternating-current voltage may be outputted to the primary winding 31 of the transformer 3, as will be described in detail later.

### <B. Transformer 3>

The transformer 3 may include one primary winding 31 and one secondary winding 32.

The primary winding 31 may have a first end coupled to the node P1 in the inverter circuit 2 and a second end coupled to the node P2 in the inverter circuit 2.

The secondary winding 32 may have a first end coupled to a node P3 in the rectifying circuit 4 to be described later, and a second end coupled to a node P4 via a rectifying switch Sf1 in the rectifying circuit 4. The rectifying switch Sf1 will be described later.

A voltage in the form of a rectangular pulse wave generated by the inverter circuit 2 may be supplied to the primary winding 31 of the transformer 3. The voltage in the form of the rectangular pulse wave supplied to the primary winding 31 may be transformed by the transformer 3, and an alternating-current voltage resulting from the transformation may be outputted from between the first end and the second end of the secondary winding 32. Note that a degree of voltage conversion of the direct-current output voltage Vout with respect to the direct-current input voltage Vin in this case may be determined based on a turns ratio between the primary winding 31 and the secondary winding 32, a switching period Tsw to be described later, and an on-duty ratio of the inverter circuit 2.

### <C. Rectifying Circuit 4 and Smoothing Circuit 5>

The rectifying circuit 4 is disposed between the pair of output terminals Tout1 and Tout2 and the secondary winding 32 of the transformer 3. For example, the rectifying circuit 4 may be disposed between the smoothing circuit 5 to be described later and the secondary winding 32. The rectifying circuit 4 may include two rectifying switches Sf1 and Sf2 that serve as rectifiers, and may thus be what is called a “synchronous rectifying circuit”.

In the rectifying circuit 4, the two rectifying switches Sf1 and Sf2 may be disposed in parallel to each other between the output terminals Tout1 and Tout2, that is, between an output line LO and a ground line LG. For example, the rectifying switch Sf2 may be disposed between the node P3 on the output line LO and the node P4 on the ground line LG. Further, the rectifying switch Sf1 may be disposed between the node P3 and the node P4, with the secondary winding 32 interposed between the rectifying switch Sf1 and the node P3 or P4. In one example, the rectifying switch Sf1 may be disposed between the second end of the secondary winding 32 and the node P4.

The rectifying switches Sf1 and Sf2 may correspond to a specific but non-limiting example of “rectifiers” in one embodiment of the disclosure.

As with the main switches Sm1 and Sm2 and the clamp switches Sc1 and Sc2 described above, the rectifying switches Sf1 and Sf2 may include any of the various type of switching devices including, without limitation, MOS-FETs, IGBTs, and HEMTs.

The smoothing circuit 5 may be disposed between the pair of output terminals Tout1 and Tout2 and the secondary winding 32. For example, the smoothing circuit 5 is disposed between the pair of output terminals Tout1 and Tout2 and the rectifying circuit 4. The smoothing circuit 5 may include one output smoothing capacitor Cout and one choke coil Lch. For example, the output smoothing capacitor Cout may be disposed between a node P5 on the output line LO and a node P6 on the ground line LG, that is, between the output terminals Tout1 and Tout2. The choke coil Lch may be interposed onto the output line LO and positioned between the nodes P3 and P5.

The output smoothing capacitor Cout may correspond to a specific but non-limiting example of a “capacitor” in one embodiment of the disclosure.

In the rectifying circuit 4 and the smoothing circuit 5 having such respective configurations, the alternating-current voltage outputted from the transformer 3 may be rectified by the two rectifying switches Sf1 and Sf2 operating as the rectifiers, and the voltage rectified at the rectifying circuit 4 may be smoothed by the output smoothing capacitor Cout and the choke coil Lch into the direct-current output voltage Vout. The direct-current output voltage Vout generated in this way may cause a direct-current output current Iout or a load current to flow to the load 9 described above, and cause electric power to be supplied from the output terminals Tout1 and Tout2 to the load 9.

Further, in the rectifying circuit 4, the rectifying switches Sf1 and Sf2 may be controlled to perform synchronous rectification, that is, controlled to be in an ON state in synchronization with time periods during which respective parasitic diodes of the rectifying switches Sf1 and Sf2, illustrated in FIG. 1, are conducting. For example, switching operations (i.e., ON and OFF operations) of the rectifying switches Sf1 and Sf2 may be controlled in accordance with respective driving signals SGf1 and SGf2 supplied from the control circuit 6 to be described later to thereby cause the rectifying switches Sf1 and Sf2 to perform such synchronous rectification.

### <D. Control Circuit 6>

The control circuit 6 may control the respective switching operations of the main switches Sm1 and Sm2 and the clamp switches Sc1 and Sc2 of the inverter circuit 2 and the respective switching operations of the rectifying switches Sf1 and Sf2 of the rectifying circuit 4. In other words, the control circuit 6 may perform switching driving to control the respective switching operations of these switches.

For example, the control circuit 6 may supply the respective driving signals SGm1, SGm2, SGc1, and SGc2 to the main switches Sm1 and Sm2 and the clamp switches Sc1 and Sc2 individually to thereby control the respective switching operations, i.e., ON and OFF operations, of these switches individually. Similarly, the control circuit 6 may supply the respective driving signals SGf1 and SGf2 to the rectifying switches Sf1 and Sf2 individually to thereby control the respective switching operations, i.e., ON and OFF operations, of these switches individually.

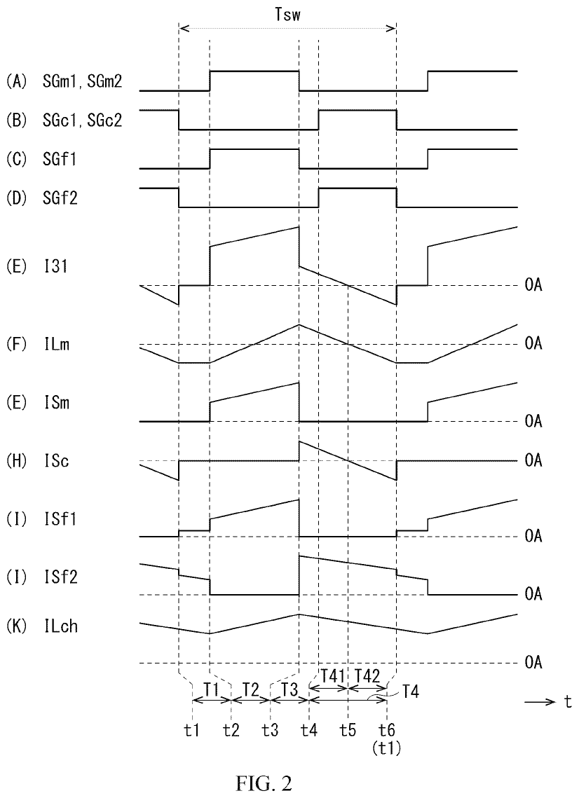

Details of the above-described switching driving to be performed by the control circuit 6 will be described later with reference to FIGS. 2 to 7.

### <Operation, Workings, and Example Effects>

### <A. Basic Operation>

In the electric power conversion apparatus 1, the direct-current input voltage Vin may be supplied from the direct-current input power supply 10 to the inverter circuit 2 via the input terminals Tin1 and Tin2. In the inverter circuit 2, the main switches Sm1 and Sm2 and the clamp switches Sc1 and Sc2 may perform the switching operations to thereby generate a voltage in the form of a rectangular pulse wave. The voltage in the form of the rectangular pulse wave may be supplied to the primary winding 31 of the transformer 3. The voltage in the form of the rectangular pulse wave supplied to the primary winding 31 may be transformed by the transformer 3, and an alternating-current voltage resulting from the transformation may thus be outputted from the secondary winding 32.

In the rectifying circuit 4, the alternating-current voltage outputted from the transformer 3, i.e., the alternating-current voltage resulting from the transformation described above, may be rectified by the rectifying switches Sf1 and Sf2 operating as rectifiers, and may thereafter be smoothed by the smoothing circuit 5. The direct-current output voltage Vout may thus be outputted from the output terminals Tout1 and Tout2. The direct-current output voltage Vout may cause the output current Iout to flow to the load 9 and cause electric power to be supplied to the load 9.

<B. Example Operation during Switching Driving>

A detailed operation of the electric power conversion apparatus 1, that is, an example operation of the electric power conversion apparatus 1 during the switching driving described above, will now be described with reference to FIGS. 2 to 7, as well as FIG. 1.

FIG. 2 is a timing chart illustrating the example operation of the electric power conversion apparatus 1 during the switching driving. In FIG. 2, part (A) illustrates a waveform of each of the driving signals SGm1 and SGm2 described above, part (B) illustrates a waveform of each of the driving signals SGc1 and SGc2 described above, and parts (C) and (D) respectively illustrate waveforms of the driving signals SGf1 and SGf2 described above. Further, part (E) illustrates a waveform of a current I31 flowing through the primary winding 31, part (F) illustrates a waveform of an excitation current ILm flowing through the secondary winding 32, part (G) illustrates a waveform of a current ISm flowing through each of the main switches Sm1 and Sm2, and part (H) illustrates a waveform of a current ISc flowing through each of the clamp switches Sc1 and Sc2. Part (I) illustrates a waveform of a current ISf1 flowing through the rectifying switch Sf1, part (J) illustrates a waveform of a current ISf2 flowing through the rectifying switch Sf2, and part (K) illustrates a waveform of a current ILch flowing through the choke coil Lch. In FIG. 2, a horizontal axis represents time t, and the same applies to subsequent timing charts.

A time period during which each of the driving signals SGm1, SGm2, SGc1, and SGc2 is in a “high (H)” state may correspond to a time period during which corresponding one of the switches (i.e., the main switches Sm1 and Sm2 and the clamp switches Sc1 and Sc2) is in an ON state. A time period during which each of the driving signals SGm1, SGm2, SGc1, and SGc2 is in a “low (L)” state may correspond to a time period during which corresponding one of the switches (i.e., the main switches Sm1 and Sm2 and the clamp switches Sc1 and Sc2) is in an OFF state.

Referring to FIG. 2, respective time periods for five kinds of operation states, that is, time periods T1, T2, T3, T41, and T42 may be set along time t. For example, in FIG. 2, a time period from a timing t1 to a timing t2 may correspond to the time period T1, a time period from the timing t2 to a timing t3 may correspond to the time period T2, and a time period from the timing t3 to a timing t4 may correspond to the time period T3. Further, a time period from the timing t4 to a timing t5 may correspond to the time period T41, and a time period from the timing t5 to a timing t6 (i.e., t1) may correspond to the time period T42. Note that in FIG. 2, a time period as a sum of the time periods T41 and T42, i.e., a time period from the timing t4 to the timing t6, is indicated as a time period T4. These five time periods may proceed in sequence (i.e., in the order of the time period T1, the time period T2, the time period T3, the time period T41, and the time period T42) repeatedly to define the switching period Tsw (=1/switching frequency fsw), as illustrated in FIG. 2. For example, a time period from the timing t1 to the timing t6 illustrated in FIG. 2 may correspond to the switching period Tsw.

In other words, the control circuit 6 may perform the above-described switching driving with the predetermined switching period Tsw including the time periods T1, T2, T3, T41, and T42 described above. As illustrated in FIG. 2, during the time period T1, the main switches Sm1 and Sm2 and the clamp switches Sc1 and Sc2 may each be set in the OFF state. That is, the time period T1 may correspond to a dead time. During the time period T2, the main switches Sm1 and Sm2 may each be set in the ON state and the clamp switches Sc1 and Sc2 may each be set in the OFF state. During the time period T3, the main switches Sm1 and Sm2 and the clamp switches Sc1 and Sc2 may each be set in the OFF state. That is, the time period T3 may correspond to the dead time. Further, during the time period T4 described above, that is, the sum of the time period T41 and the time period T42, the main switches Sm1 and Sm2 may each be set in the OFF state and the clamp switches Sc1 and Sc2 may each be set in the ON state.

The time period T1 may correspond to a specific but non-limiting example of a “first time period” in one embodiment of the disclosure, and the time period T2 may correspond to a specific but non-limiting example of a “second time period” in one embodiment of the disclosure. The time period T3 may correspond to a specific but non-limiting example of a “third time period” in one embodiment of the disclosure, and the time period T4 may correspond to a specific but non-limiting example of a “fourth time period” in one embodiment of the disclosure.

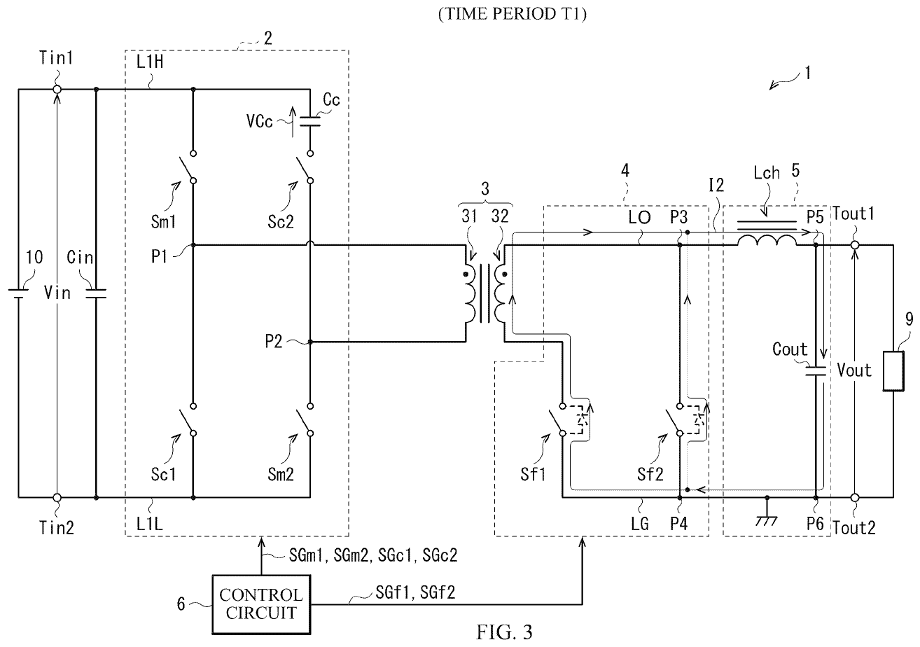

FIGS. 3 to 7 are circuit diagrams illustrating the operation states of the electric power conversion apparatus 1 during the respective time periods T1, T2, T3, T41, and T42 in FIG. 2. An example operation in each of these operation states will be described in detail below with reference to FIG. 2. For convenience, in FIGS. 3 to 7, each switch (i.e., each of the main switches Sm1 and Sm2, the clamp switches Sc1 and Sc2, and the rectifying switches Sf1 and Sf2) is schematically illustrated in a switch shape.

### <Time Period T1>

First, during the time period T1 illustrated in FIG. 3, the main switches Sm1 and Sm2 and the clamp switches Sc1 and Sc2 may each be set in the OFF state (see parts (A) and (B) of FIG. 2), as described above. This may prevent a primary circuit current (i.e., a current I1) from flowing on a primary side of the transformer 3 during the time period T1. Further, during the time period T1, the rectifying switches Sf1 and Sf2 may each be set in an OFF state (see parts (C) and (D) of FIG. 2). This may allow a secondary circuit current (i.e., a current I2) to flow on a secondary side of the transformer 3 during the time period T1. The current I2 may be a sum of an excitation current, i.e., a current commutated to the secondary side with an excitation inductance of the transformer 3 as an energy source, and a freewheeling current, i.e., a current flowing with the choke coil Lch as an energy source. The excitation current and the freewheeling current may flow over the following respective paths. The excitation current may flow from the secondary winding 32, through the output line LO, the choke coil Lch, the output smoothing capacitor Cout, the ground line LG, and the parasitic diode of the rectifying switch Sf1 in this order, and back to the secondary winding 32. The freewheeling current may flow from the choke coil Lch, through the output smoothing capacitor Cout, the ground line LG, and the parasitic diode of the rectifying switch Sf2 in this order, and back to the choke coil Lch.

### <Time Period T2>

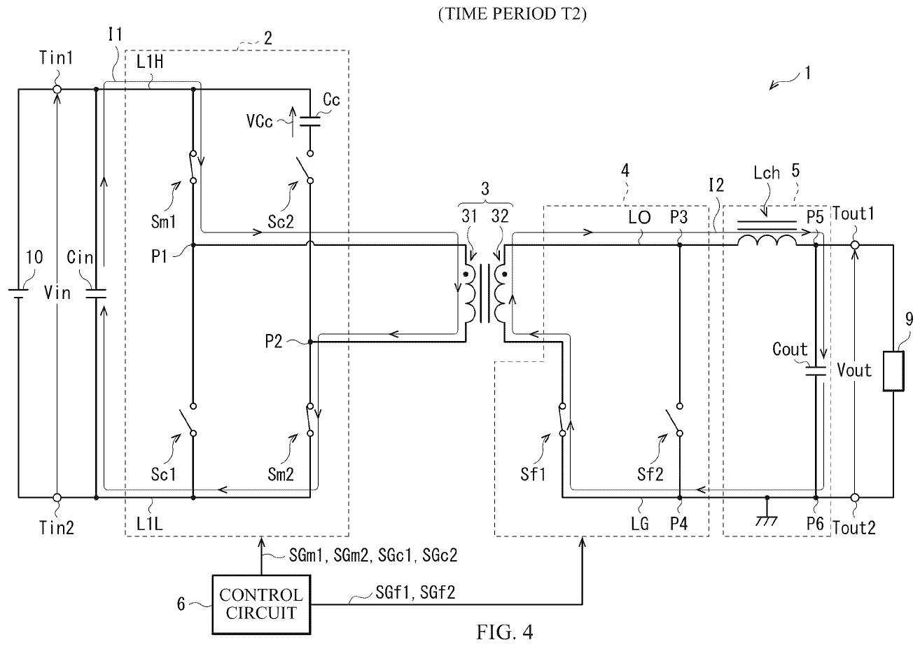

Thereafter, during the time period T2 illustrated in FIG. 4, the main switches Sm1 and Sm2 may each be set in the ON state and the clamp switches Sc1 and Sc2 may each be set in the OFF state (see parts (A) and (B) of FIG. 2), as described above. This may allow, during the time period T2, the primary circuit current (i.e., the current I1) to flow on the primary side of the transformer 3 over a path from the input smoothing capacitor Cin, through the primary high voltage line L1H, the main switch Sm1, the primary winding 31, the main switch Sm2, and the primary low voltage line L1L in this order, and back to the input smoothing capacitor Cin. Further, during the time period T2, the rectifying switch Sf1 may be set in the ON state and the rectifying switch Sf2 may be set in the OFF state (see parts (C) and (D) of FIG. 2). This may allow, during the time period T2, the secondary circuit current (i.e., the current I2) to flow on the secondary side of the transformer 3 over the path from the secondary winding 32, through the output line LO, the choke coil Lch, the output smoothing capacitor Cout, the ground line LG, and the rectifying switch Sf1 in this order, and back to the secondary winding 32.

### <Time Period T3>

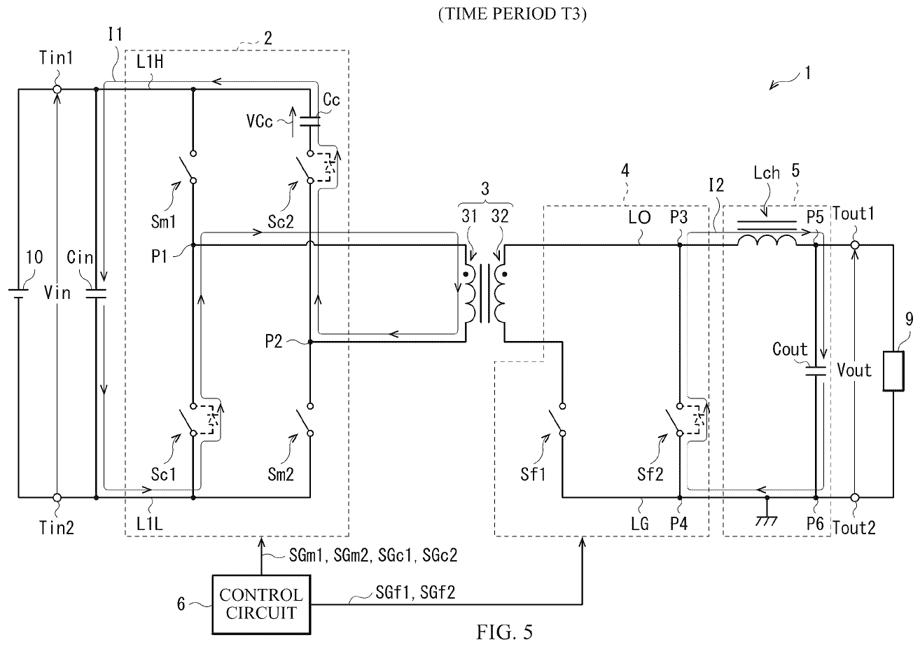

Thereafter, during the time period T3 illustrated in FIG. 5, the main switches Sm1 and Sm2 and the clamp switches Sc1 and Sc2 may each be set in the OFF state (see parts (A) and (B) of FIG. 2), as described above. This may allow, during the time period T3, the primary circuit current (i.e., the current I1) to flow on the primary side of the transformer 3 over a path from the primary winding 31, through a parasitic diode of the clamp switch Sc2, the clamp capacitor Cc, the primary high voltage line L1H, the input smoothing capacitor Cin, the primary low voltage line L1L, and a parasitic diode of the clamp switch Sc1 in this order, and back to the primary winding 31. During the time period T3, the excitation inductance of the transformer 3 may serve as an energy source to allow the current I1 to flow. Further, during the time period T3, the rectifying switches Sf1 and Sf2 may each be set in the OFF state (see parts (C) and (D) of FIG. 2). This may allow, during the time period T3, the secondary circuit current (i.e., the current I2) to flow on the secondary side of the transformer 3 over a path from the choke coil Lch, through the output smoothing capacitor Cout, the ground line LG, and the parasitic diode of the rectifying switch Sf2 in this order, and back to the coke coil Lch.

### <Time Period T41>

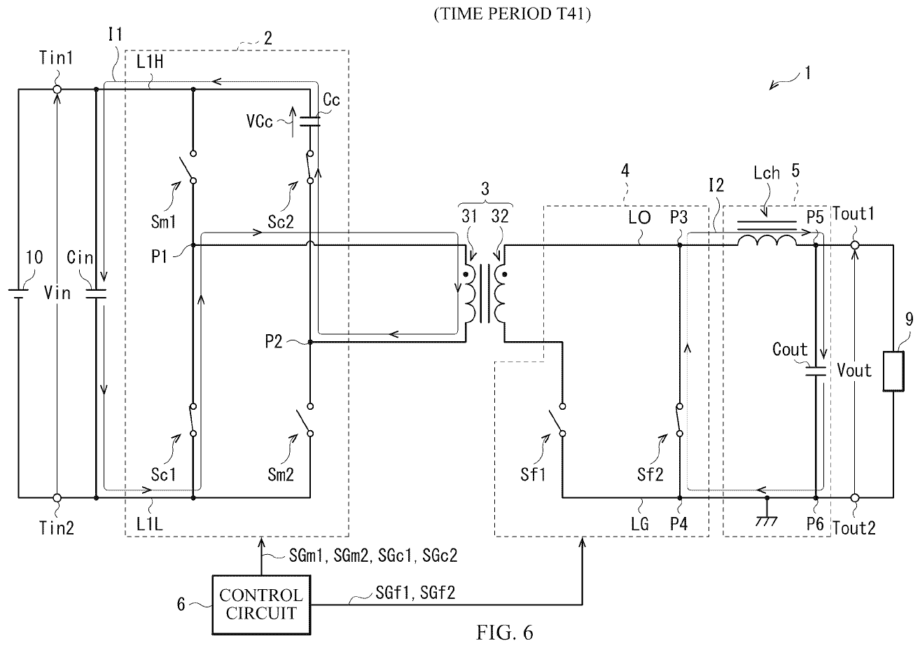

Thereafter, during the time period T41 illustrated in FIG. 6, the main switches Sm1 and Sm2 may each be set in the OFF state and the clamp switches Sc1 and Sc2 may each be set in the ON state (see parts (A) and (B) of FIG. 2), as described above. This may allow, during the time period T41, the primary circuit current (i.e., the current I1) to flow on the primary side of the transformer 3 over the path from the primary winding 31, through the clamp switch Sc2, the clamp capacitor Cc, the primary high voltage line L1H, the input smoothing capacitor Cin, the primary low voltage line L1L, and the clamp switch Sc1 in this order, and back to the primary winding 31. During the time period T41, the excitation inductance of the transformer 3 may serve as the energy source to allow the current I1 to flow, and the clamp capacitor Cc may be charged with the current I1. Further, during the time period T41, the rectifying switch Sf1 may be set in the OFF state and the rectifying switch Sf2 may be set in the ON state (see parts (C) and (D) of FIG. 2). This may allow, during the time period T41, the secondary circuit current (i.e., the current I2) to flow on the secondary side of the transformer 3 over the path from the choke coil Lch, through the output smoothing capacitor Cout, the ground line LG, and the rectifying switch Sf2 in this order, and back to the coke coil Lch.

### <Time Period T42>

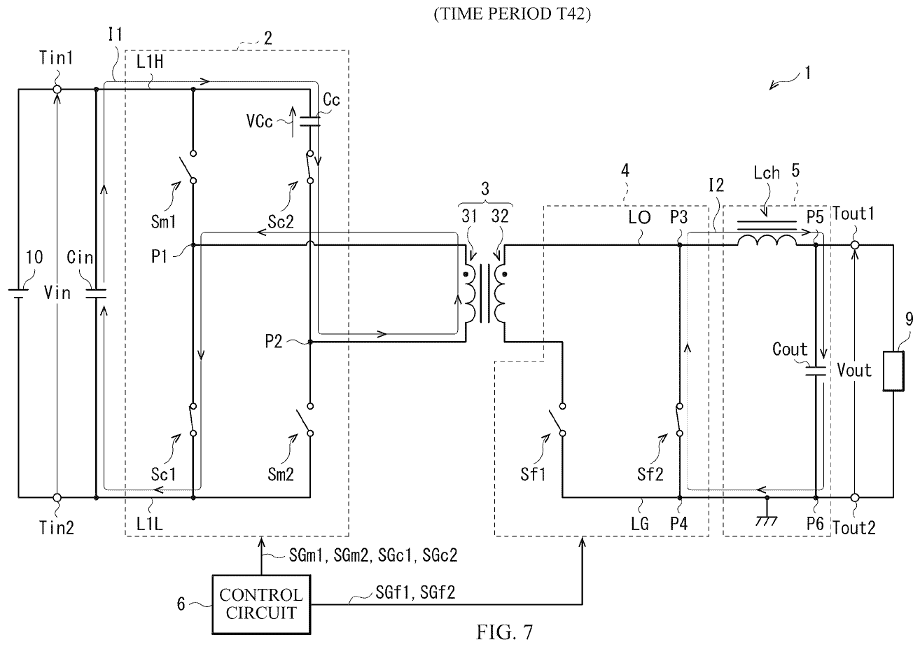

Thereafter, during the time period T42 illustrated in FIG. 7 also, the main switches Sm1 and Sm2 may each be set in the OFF state and the clamp switches Sc1 and Sc2 may each be set in the ON state (see parts (A) and (B) of FIG. 2), similarly to the time period T41 described above. Further, during the time period T42, the rectifying switch Sf1 may be set in the OFF state and the rectifying switch Sf2 may be set in the ON state (see parts (C) and (D) of FIG. 2), similarly to the time period T41 described above. This may allow the secondary circuit current (i.e., the current I2) to flow on the secondary side of the transformer 3 over the same path as that during the time period T41 described above. In contrast, the primary circuit current (i.e., the current I1) may flow on the primary side of the transformer 3 over a path reverse to that during the time period T41 described above. During the time period T42, the current I1 may thus flow from the clamp capacitor Cc, through the clamp switch Sc2, the primary winding 31, the clamp switch Sc1, the primary low voltage line L1L, the input smoothing capacitor Cin, and the primary high voltage line L1H in this order, and back to the clamp capacitor Cc. During the time period T42, the clamp capacitor Cc charged with the excitation current may serve as an energy source to allow the current I1 to flow.

This is the end of the description of the example operation, of the electric power conversion apparatus 1, during the switching driving illustrated in FIG. 2.

### <C. Workings and Example Effects>

Workings and example effects of the electric power conversion apparatus 1 according to the example embodiment will now be described in detail in comparison with Comparative Example 1, etc.

Regarding an electric power conversion apparatus (e.g., a DC-to-DC converter) mountable on, for example, a vehicle, a wider input voltage range is demanded in general in order to meet a plurality of battery cell specifications with a single converter. Further, as a converter having a circuit configuration that helps to allow a duty ratio to be set to 50% or higher by resetting a transformer (a main transformer) at a voltage higher than the input voltage, an active clamp single forward (ACSF) converter has been known.

As described above, the ACSF converter helps to achieve a duty ratio of 50% or higher, which in turn helps to achieve a wider input voltage range and a reduction in the number of circuit components. However, in the ACSF converter, as described above, a voltage higher than the input voltage is to be applied to switching (SW) devices on the primary side of the transformer. This would necessitate high-withstand-voltage SW devices, thus leading to higher parts price, that is, a cost increase.

Here, the electric power conversion apparatus 1 according to the example embodiment helps to reduce the voltage to be applied to the SW devices on the primary side of the transformer 3, that is, the main switches Sm1 and Sm2 and the clamp switches Sc1 and Sc2, as will be detailed later, owing to having the circuit configuration described above and performing the switching driving described above.

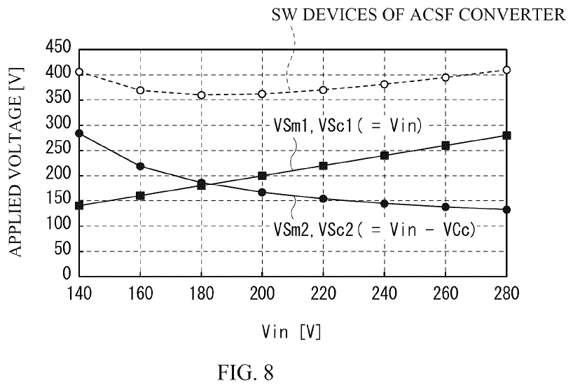

FIG. 8 illustrates an example of corresponding relationships between the direct-current input voltage Vin and voltages VSm1, VSm2, VSc1, and VSc2 applied to the SW devices on the primary side of the transformer 3, that is, the main switches Sm1 and Sm2 and the clamp switches Sc1 and Sc2, in the example embodiment. In addition, for reference, a voltage applied to SW devices on the primary side in the ACSF converter described above is also illustrated in FIG. 8. As seen from FIG. 8, the voltages VSm1, VSm2, VSc1, and VSc2 applied to the respective SW devices on the primary side in the example embodiment are all lower than the voltage applied to the SW devices on the primary side in the ACSF converter.

### Comparative Example 1

Comparative Example 1 described below also helps to lower the voltages to be applied to SW devices on the primary side, compared to a case with the ACSF converter.

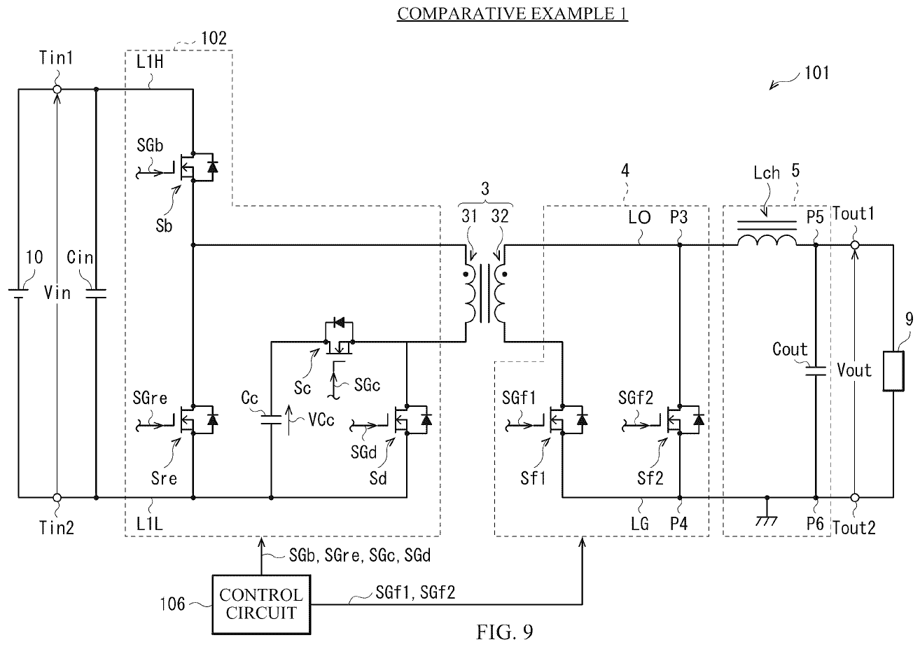

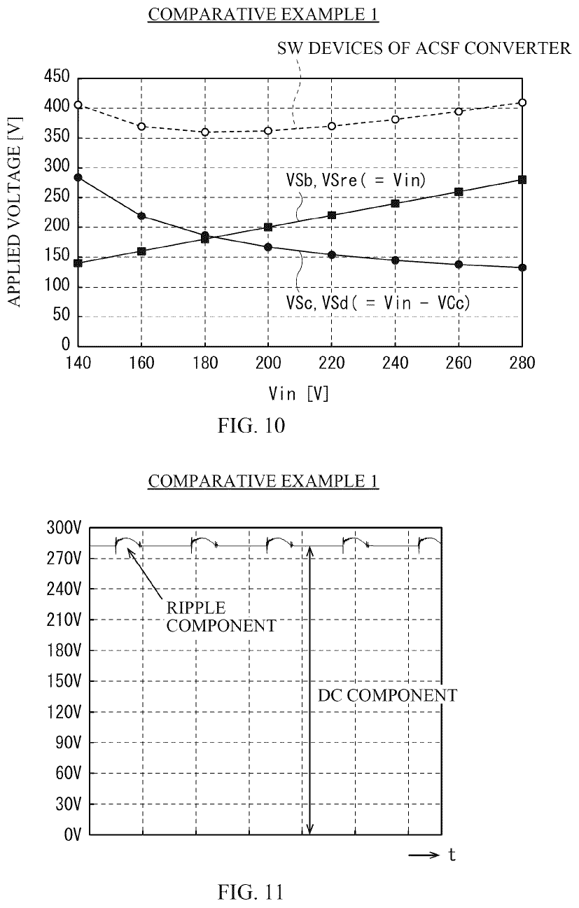

FIG. 9 is a circuit diagram illustrating a schematic configuration example of an electric power conversion apparatus 101 according to Comparative Example 1. FIG. 10 illustrates an example of corresponding relationships between the direct-current input voltage Vin and voltages VSb, VSre, VSc, and VSd applied to SW devices on the primary side of the transformer 3, that is, a cut-off switch Sb, a reset switch Sre, and switches Sc and Sd, in Comparative Example 1. In addition, for reference, the voltage applied to the SW devices on the primary side in the ACSF converter described above is also illustrated in FIG. 10. FIG. 11 is a timing chart illustrating an example of temporal changes of a direct-current (DC) component and a ripple component in Comparative Example 1.

The electric power conversion apparatus 101 of Comparative Example 1 illustrated in FIG. 9 may correspond to the electric power conversion apparatus 1 according to the example embodiment illustrated in FIG. 1 in which the inverter circuit 2 and the control circuit 6 are replaced with an inverter circuit 102 and a control circuit 106, respectively. For example, in the inverter circuit 102, the cut-off switch Sb and the reset switch Sre may be disposed in series to each other and in this order between the primary high voltage line L1H and the primary low voltage line L1L. A node between the cut-off switch Sb and the reset switch Sre may be coupled to the first end of the primary winding 31. The two switches Sc and Sd and the clamp capacitor Cc may be disposed between the second end of the primary winding 31 and the primary low voltage line L1L. For example, between the second end of the primary winding 31 and the primary low voltage line L1L, the switch Sc and the clamp capacitor Cc may be disposed in series to each other and in this order, and the switch Sd may be disposed in parallel to such a series arrangement structure of the switch Sc and the clamp capacitor Cc. The control circuit 106 may supply driving signals SGb, SGre, SGc, SGd, SGf1, and SGf2 corresponding to the respective SW devices (i.e., the cut-off switch Sb, the reset switch Sre, the switches Sc and Sd, and the rectifying switches Sf1 and Sf2) to those respective SW devices.

In this way, the electric power conversion apparatus 101 of Comparative Example 1 may have a configuration in which the cut-off switch Sb and the reset switch Sre are added to the primary side of the transformer 3 in the ACSF converter described above. This helps to lower the voltages to be applied to the SW devices on the primary side in Comparative Example 1, as in the example embodiment, compared to the case with the ACSF converter. For example, as seen from FIG. 10, the voltages VSb, VSre, VSc, and VSd applied to the SW devices on the primary side in Comparative Example 1 are all lower than the voltage applied to the SW devices on the primary side in the ACSF converter.

However, the electric power conversion apparatus 101 of Comparative Example 1 may raise the following concern in selecting the clamp capacitor Cc. In selecting the clamp capacitor Cc, capacitance may be determined based on the temporal changes of the DC component and the ripple component, as illustrated in, for example, FIG. 11. In view of the sum of these components, the clamp capacitor Cc would have to be large in capacity and high in withstand voltage. A large-capacity and high-withstand-voltage capacitor is expensive in general, and using such a capacitor as the clamp capacitor Cc would result in increased cost of the electric power conversion apparatus 101 of Comparative Example 1.

### Example Embodiment

In contrast, the electric power conversion apparatus 1 according to the example embodiment helps to achieve the following advantages, owing to having the circuit configuration described above and performing the switching driving described above. For example, as will be detailed later, the electric power conversion apparatus 1 helps to reduce the cost of the capacitor to be used as the clamp capacitor Cc while lowering the voltages VSm1, VSm2, VSc1, and VSc2 to be applied to the SW devices on the primary side, compared to Comparative Example 1.

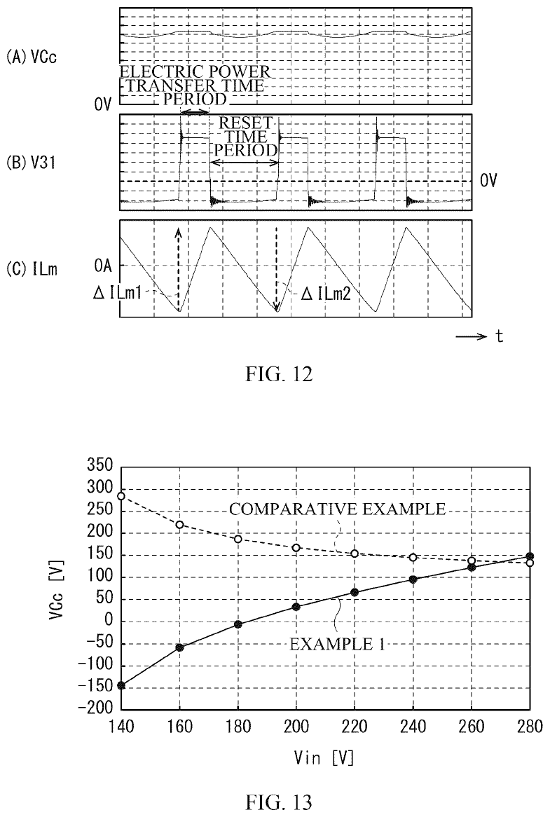

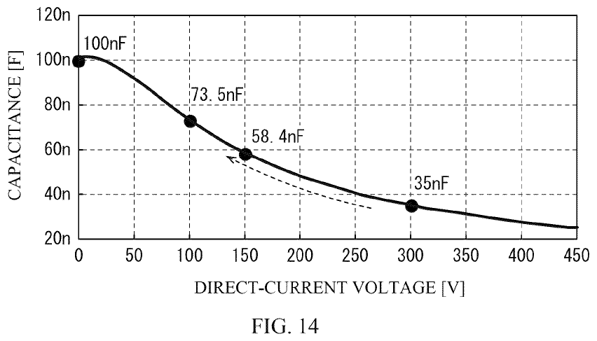

FIG. 12 is a timing chart illustrating an example of temporal changes of multiple kinds of voltages and a current in the example embodiment. In FIG. 12, part (A) illustrates a waveform of a voltage across the clamp capacitor Cc, i.e., a clamp voltage VCc illustrated in FIG. 1, part (B) illustrates a waveform of a voltage V31 across the primary winding 31, and part (C) illustrates the waveform of the excitation current ILm generated at the secondary winding 32. FIG. 13 illustrates an example of a corresponding relationship between the direct-current input voltage Vin and the clamp voltage VCc in each of Example 1 according to the example embodiment and Comparative Example 1 described above. FIG. 14 illustrates an example of a DC bias characteristic of the clamp capacitor Cc of the example embodiment.

The electric power conversion apparatus 1 according to the example embodiment may be configured to allow a reset voltage Vreset of the transformer 3 illustrated in FIG. 1 to be obtained by subtracting the clamp voltage VCc from the direct-current input voltage Vin, that is, to satisfy the following expression: Vreset=Vin−VCc. Further, in the electric power conversion apparatus 1, the voltages VSm1, VSm2, VSc1, and VSc2 to be applied to the SW devices on the primary side of the transformer 3 described above may satisfy the following relationships, as illustrated in FIG. 8 described above:

$$V Sm 1 = V in ;$$

$$V Sc 1 = V in ;$$

$$V Sm 2 = V in - V Cc ; and$$

$$V Sc 2 = V in - V Cc .$$

As described above, the electric power conversion apparatus 1 may be configured to allow the reset voltage Vreset of the transformer 3 to be obtained as Vreset=(Vin−VCc). This helps, as described below, to reduce a steady state voltage (i.e., the clamp voltage VCc) to be applied to the clamp capacitor Cc, compared to that in Comparative Example 1.

For example, first, the clamp voltage VCc in the example embodiment may be negatively fed back with the excitation current ILm of the transformer 3 to determine an operating voltage. An amount of increase ΔILm1 and an amount of decrease ΔILm2 of the excitation current ILm, illustrated in part (C) of FIG. 12, at this time may be respectively defined by Expressions (1) and (2) below, based on the switching period Tsw, a duty ratio Dt, and a primary inductance Lp of the transformer 3.

$$\{ \begin{matrix}Δ ILm 1 = \frac{{V}_{in}}{Lp} \times \frac{Dt}{{T}_{SW}} & ( 1 ) \\ Δ ILm 2 = \frac{{V}_{in} - V Cc}{Lp} \times \frac{1 - Dt}{{T}_{SW}} & ( 2 )\end{matrix}$$

In a steady state, the amount of increase ΔILm1 and the amount of decrease ΔILm2 of the excitation current ILm are equal (i.e., ΔILm1=ΔILm2). Accordingly, the clamp volage VCc in the example embodiment may be defined by Expression (3) below.

$$V Cc = {V}_{in} \times ( 1 - \frac{Dt}{1 - Dt} ) \qquad ( 3 )$$

$$( \begin{matrix}Dt < 0.5 : V Cc > 0 \\ Dt = 0.5 : V Cc = 0 \\ Dt > 0.5 : V Cc < 0\end{matrix} )$$

In contrast, the clamp voltage VCc in each of the above-described ACSF converter and Comparative Example 1 may be defined by Expression (4) below.

$$V Cc = {V}_{in} \times ( \frac{Dt}{1 - Dt} ) \qquad ( 4 )$$

Comparing Expression (3) and Expression (4) indicates that the clamp voltage VCc in Example 1 of the example embodiment is lower than that in Comparative Example 1, as illustrated in, for example, FIG. 13. Accordingly, for example, when typical multilayer ceramic capacitors (MLCCs) are used as capacitors to configure the clamp capacitor Cc, the example embodiment helps to reduce the number of the capacitors to be coupled in parallel to configure the clamp capacitor Cc. One reason for this is that, for example, as indicated in a dashed arrow in FIG. 14, the capacitance of each capacitor included in the clamp capacitor Cc increases as the clamp voltage VCc (a direct-current voltage) decreases. This indicates that the example embodiment helps to achieve cost reduction through reducing the number of the capacitors to be included in the clamp capacitor Cc, compared to Comparative Example 1.

In this way, owing to having the circuit configuration described above and performing the switching driving described above, the example embodiment provides the following workings and example effects. For example, as with Comparative Example 1, the example embodiment helps to lower the voltages VSm1, VSm2, VSc1, and VSc2 to be applied to the SW devices on the primary side of the transformer 3, that is, the main switches Sm1 and Sm2 and the clamp switches Sc1 and Sc2, compared to the case with the ACSF converter. Further, as described above, the example embodiment helps to reduce the number of the capacitors to be included in the clamp capacitor Cc, compared to Comparative Example 1. As a result, the example embodiment helps to reduce cost of the electric power conversion apparatus 1, compared to Comparative Example 1. Further, compared to Comparative Example 1, the example embodiment helps to improve transient response defined by a time constant determined by the excitation inductance of the transformer 3 and the capacitance of the clamp capacitor Cc.

### 2. Modification Examples

Modification Examples of the foregoing example embodiment will now be described. In the following description, the same reference signs are assigned to components the same as those in the example embodiment, and descriptions thereof will be omitted as appropriate.

### Modification Example 1

### Configuration

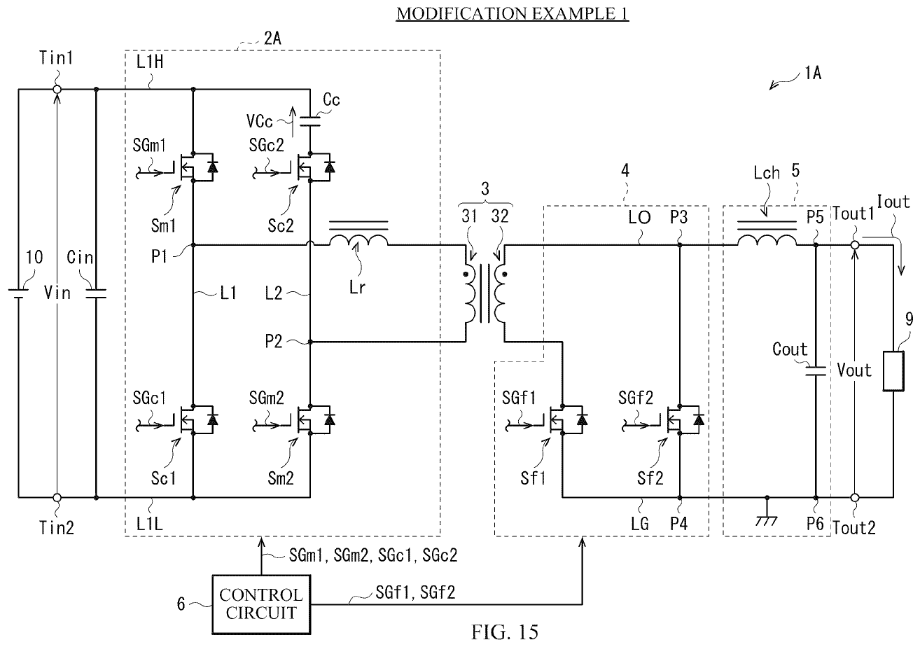

FIG. 15 is a circuit diagram illustrating a schematic configuration example of an electric power conversion apparatus 1A according to Modification Example 1. The electric power conversion apparatus 1A according to Modification Example 1 may correspond to the electric power conversion apparatus 1 according to the example embodiment illustrated in FIG. 1 in which the inverter circuit 2 is replaced with an inverter circuit 2A, with the remainder of configuration being unchanged.

The inverter circuit 2A may have a configuration similar to that of the inverter circuit 2, except for further including a resonant coil Lr. In the example illustrated in FIG. 15, the resonant coil Lr may be disposed on a first end side of the primary winding 31, that is, between the primary winding 31 and the node P1 on the coupling line L1. In some embodiments, the resonant coil Lr may be disposed on a second end side of the primary winding 31, that is, between the primary winding 31 and the node P2 on the coupling line L2.

### <Workings and Example Effects>

Basically, Modification Example 1 with such a configuration helps to achieve effects similar to those achievable with the example embodiment, through similar workings.

In addition, owing to the resonant coil Lr disposed on the first end side or the second end side of the primary winding 31, Modification Example 1 helps to achieve the following effects. During the time period T1 described above, the excitation current may continue to flow also on the primary side of the transformer 3, which helps to remove electric charge of a parasitic capacitance between a drain and a source of each of the main switches Sm1 and Sm2. This helps to reduce a turn loss of each of the main switches Sm1 and Sm2, which in turn helps to suppress an electric power loss in the electric power conversion apparatus 1A.

### Modification Example 2

### Configuration

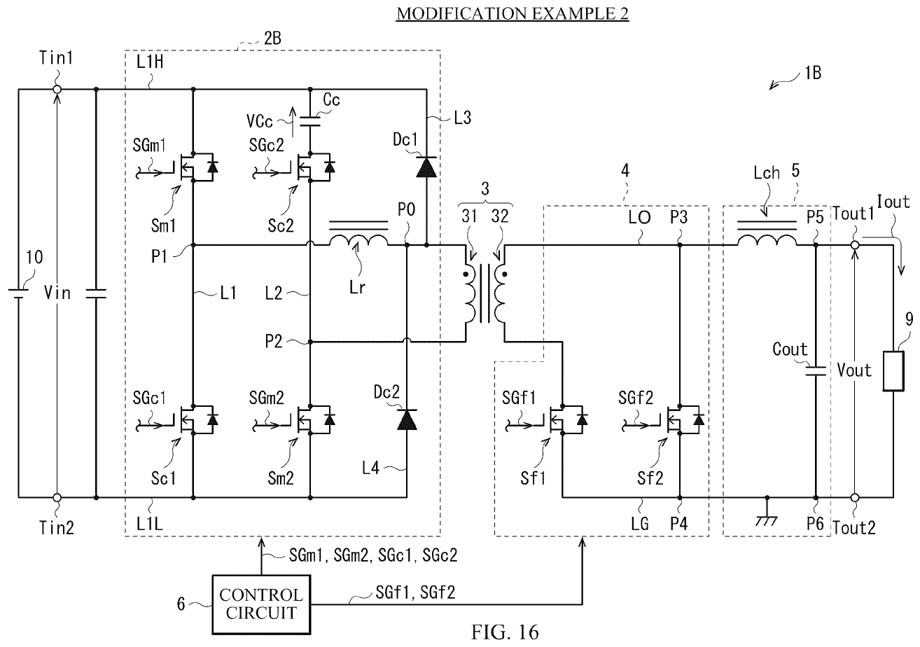

FIG. 16 is a circuit diagram illustrating a schematic configuration example of an electric power conversion apparatus 1B according to Modification Example 2. The electric power conversion apparatus 1B according to Modification Example 2 may correspond to the electric power conversion apparatus 1A according to Modification Example 1 illustrated in FIG. 15 in which the inverter circuit 2A is replaced with an inverter circuit 2B, with the remainder of configuration being unchanged.

The inverter circuit 2B may have a configuration similar to that of the inverter circuit 2A, except for further including two coupling lines L3 and L4 and two clamp diodes Dc1 and Dc2 described below. In some embodiments, the resonant coil Lr may be omitted from the inverter circuit 2B, similarly to the configuration of the inverter circuit 2.

In the inverter circuit 2B, the coupling line L3 may couple a node P0 on the first end side of the primary winding 31 and the input terminal Tin1 (the primary high voltage line L1H) to each other. Further, the coupling line L4 may couple the node P0 and the input terminal Tin2 (the primary low voltage line L1L) to each other. The clamp diode Dc1 may be disposed on the coupling line L3, and the clamp diode Dc2 may be disposed on the coupling line L4. For example, the clamp diode Dc1 may have an anode coupled to the node P0 and a cathode coupled to the input terminal Tin1. The clamp diode Dc2 may have an anode coupled to the input terminal Tin2 and a cathode coupled to the node P0.

The coupling line L3 may correspond to a specific but non-limiting example of a “third coupling line” in one embodiment of the disclosure. The coupling line L4 may correspond to a specific but non-limiting example of a “fourth coupling line” in one embodiment of the disclosure. The clamp diode Dc1 may correspond to a specific but non-limiting example of a “first clamp diode” in one embodiment of the disclosure. The clamp diode Dc2 may correspond to a specific but non-limiting example of a “second clamp diode” in one embodiment of the disclosure. The node P0 may correspond to a specific but non-limiting example of a “node” in one embodiment of the disclosure.

### <Operation, Workings, and Example Effects>

Basically, the electric power conversion apparatus 1B according to Modification Example 2 having such a configuration helps to achieve effects similar to those achievable with the example embodiment and/or Modification Example 1, through similar workings.

In addition, owing to the provision of the two clamp diodes Dc1 and Dc2 described above, Modification Example 2 helps to achieve the following effects.

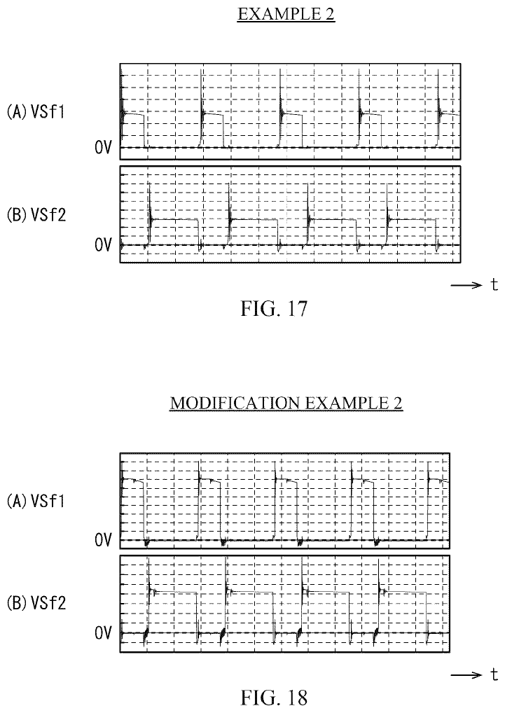

FIG. 17 is a timing chart illustrating an example of temporal changes of multiple kinds of voltages in Example 2 according to the example embodiment. FIG. 18 is a timing chart illustrating an example of temporal changes of the multiple kinds of voltages in Modification Example 2. In each of FIGS. 17 and 18, part (A) illustrates a waveform of a voltage VSf1 applied to the rectifying switch Sf1, and part (B) illustrates a waveform of a voltage VSf2 applied to the rectifying switch Sf2.

Comparing the voltages VSf1 and VSf2 in Example 2 illustrated in parts (A) and (B) of FIG. 17 and the voltages VSf1 and VSf2 in Modification Example 2 illustrated in parts (A) and (B) of FIG. 18 indicate that in Modification Example 2, a surge voltage occurring at each of the rectifying switches Sf1 and Sf2 in the rectifying circuit 4 is suppressed, compared to that in Example 2. Thus, owing to the provision of the two clamp diodes Dc1 and Dc2 described above, Modification Example 2 helps to suppress the surge voltage occurring in the rectifying circuit 4, compared to Example 2 according to the example embodiment.

### Modification Examples 3, 3-1, and 3-2

### Configuration

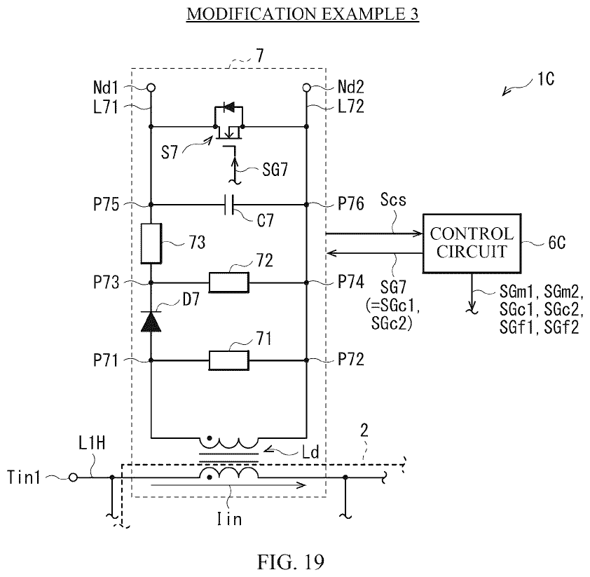

FIG. 19 is a circuit diagram illustrating a configuration example of a current detection circuit 7 and a control circuit 6C of an electric power conversion apparatus 1C according to Modification Example 3. The electric power conversion apparatus 1C according to Modification Example 3 may correspond to the electric power conversion apparatus 1 according to the example embodiment illustrated in FIG. 1 in which the current detection circuit 7 described below is further provided and the control circuit 6 is replaced with the control circuit 6C, with the remainder of configuration being unchanged.

The current detection circuit 7 may detect a direct-current input current Iin flowing along the primary high voltage line L1H in the inverter circuit 2 of the electric power conversion apparatus 1C. The current detection circuit 7 may supply a result of detection of the input current Iin as a current detection signal Scs to the control circuit 6C, as illustrated in FIG. 19.

The current detection circuit 7 may include two coupling lines L71 and L72 respectively coupled to detection nodes Nd1 and Nd2, a current detection coil Ld, a reset circuit 71, two resistors 72 and 73, a diode D7, a capacitor C7, and a synchronous switch S7.

The current detection coil Ld may include a primary winding interposed onto the primary high voltage line L1H, and a secondary winding positioned between a node P71 on the coupling line L71 and a node P72 on the coupling line L72. The reset circuit 71 may be disposed in parallel to the secondary winding of the current detection coil Ld and positioned between the nodes P71 and P72 described above. The resistor 72, i.e., a detection resistor, may be positioned between a node P73 on the coupling line L71 and a node P74 on the coupling line L72. The diode D7 may be interposed onto the coupling line L71 and positioned between the nodes P71 and P73 described above. For example, the diode D7 may have an anode coupled to the node P71 and a cathode coupled to the node P73. The resistor 73 may be interposed onto the coupling line L71 and positioned between the node P73 and anode P75. The capacitor C7 may be positioned between the node P75 and a node P76 on the coupling line L72. The resistor 73 and the capacitor C7 may configure a noise filter.

The synchronous switch S7 may be disposed in parallel to the capacitor C7 and positioned between the nodes P75 and P76 described above. The synchronous switch S7 may be controlled to perform ON and OFF operations at predetermined timings in accordance with a driving signal SG7 supplied from the control circuit 6C. For example, in Modification Example 3, the synchronous switch S7 may perform the ON and OFF operations at timings synchronized with the clamp switches Sc1 and Sc2.

The control circuit 6C may generate the driving signals SGm1, SGm2, SGc1, SGc2, SGf1, and SGf2 described above, based on the current detection signal Scs, that is, the result of detection of the input current Iin by the current detection circuit 7, and perform the switching driving described above. Further, in Modification Example 3, as described above, the control circuit 6C may control the synchronous switch S7 through the use of the driving signal SG7, that is, the driving signals SGc1 and SGc2, to cause the synchronous switch S7 to perform the ON and OFF operations at the timings synchronized with the clamp switches Sc1 and Sc2.

### <Operation, Workings, and Example Effects>

Basically, the electric power conversion apparatus 1C according to Modification Example 3 having such a configuration helps to achieve effects similar to those achievable with any of the example embodiment and Modification Examples 1 and 2, through similar workings.

### Modification Example 3

In addition, in Modification Example 3, the current detection circuit 7 to detect the input current Iin may include the synchronous switch S7 to be controlled to perform the ON and OFF operations at predetermined timings, that is, the timings synchronized with the clamp switches Sc1 and Sc2. Owing to such a configuration, Modification Example 3 helps to achieve the following effects, compared to Comparative Example 2 described below.

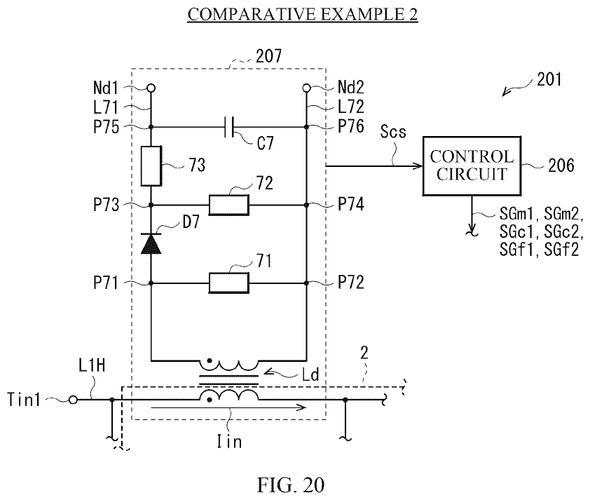

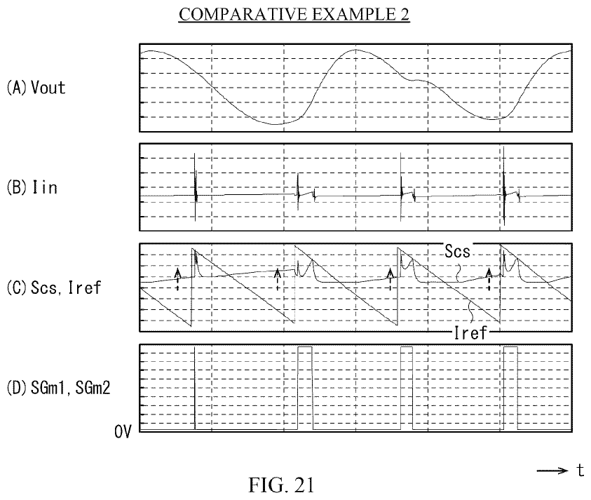

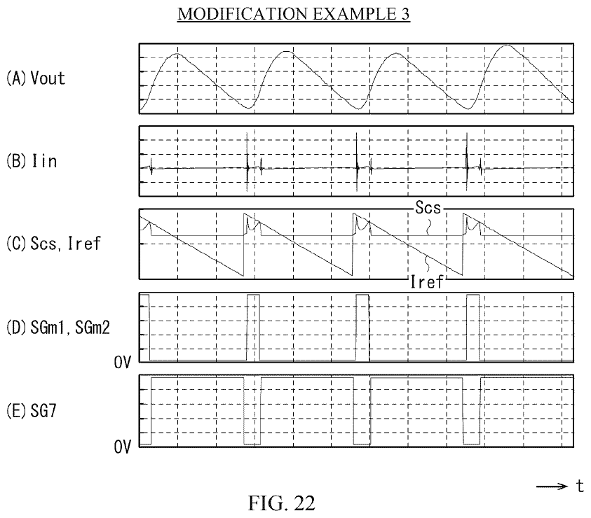

FIG. 20 is a circuit diagram illustrating a schematic configuration example of a current detection circuit 207 and a control circuit 206 of an electric power conversion apparatus 201 according to Comparative Example 2. FIG. 21 is a timing chart illustrating an example operation during a current detection operation in Comparative Example 2. FIG. 22 is a timing chart illustrating an example operation during the current detection operation in Modification Example 3. In each of FIGS. 21 and 22, part (A) illustrates a waveform of the direct-current output voltage Vout, part (B) illustrates a waveform of the input current Iin described above, part (C) illustrates a waveform of the current detection signal Scs and a waveform of a reference current Iref generated by feedback control, and part (D) illustrates the waveform of each of the driving signals SGm1 and SGm2 corresponding to the main switches Sm1 and Sm2. FIG. 22 also illustrates, in part (E), a waveform of the driving signal SG7 described above.

The current detection circuit 207 of the electric power conversion apparatus 201 of Comparative Example 2 illustrated in FIG. 20 may have a configuration similar to that of the current detection circuit 7 of Modification Example 3 illustrated in FIG. 19, except for not including the synchronous switch S7. Accordingly, the control circuit 206 of the electric power conversion apparatus 201 of Comparative Example 2 illustrated in FIG. 20 may not supply the driving signal SG7 to the current detection circuit 207, unlike the control circuit 6C of Modification Example 3 illustrated in FIG. 19.

In Comparative Example 2 having such a configuration, as indicated by dashed arrows in part (C) of FIG. 21, for example, a voltage value of the current detection signal Scs will increase during a time period during which the main switches Sm1 and Sm2 are in the OFF state, that is, a time period during which the driving signals SGm1 and SGm2 are in the “L” state as illustrated in part (D) of FIG. 21. In other words, during the time period during which the main switches Sm1 and Sm2 are in the OFF state, an offset voltage will occur on the current detection signal Scs because a current flows in a direction of electric power transfer in the electric power conversion apparatus 201. In such a case, the value of the current detection signal Scs will further increase due to a charge current of the parasitic capacitance occurring when the main switches Sm1 and Sm2 change from the OFF state to the ON state. Thus, at the instant when the main switches Sm1 and Sm2 change from the OFF state to the ON state, the value of the current detection signal Scs will reach that of the reference current Iref. As a result, the driving signals SGm1 and SGm2 will become narrower in pulse width, which can make the direct-current output voltage Vout unstable.

In contrast, in Modification Example 3, the synchronous switch S7 in the current detection circuit 7 may perform the ON and OFF operations at the timings synchronized with the clamp switches Sc1 and Sc2. This helps to achieve the following effects, unlike in Comparative Example 2 described above. For example, as illustrated in part (C) of FIG. 22, Modification Example 3 helps to avoid an increase in voltage value of the current detection signal Scs (i.e., the occurrence of the offset voltage on the current detection signal Scs) during the time period during which the clamp switches Sc1 and Sc2 (and the synchronous switch S7) are in the OFF state, unlike Comparative Example 2. Further, when the driving signals SGc1 and SGc2 for the clamp switches Sc1 and Sc2 are used as the driving signal SG7 to drive the synchronous switch S7, the following is achievable. That is, although a small offset voltage may occur during a time period from when the clamp switches Sc1 and Sc2 are turned off to when the main switches Sm1 and Sm2 are turned on, the offset voltage has a smaller value than in Comparative Example 2. Accordingly, unlike Comparative Example 2, Modification Example 3 helps to prevent the driving signals SGm1 and SGm2 from becoming narrower in pulse width, which in turn helps to allow the direct-current output voltage Vout to be stabler than in Comparative Example 2.

### Modification Examples 3-1 and 3-2

In some embodiments, the predetermined timings at which the synchronous switch S7 is to perform the ON and OFF operations may be changed, as in Modification Examples 3-1 and 3-2, for example. In Modification Example 3 described above, the synchronous switch S7 may perform the ON and OFF operations at the timings synchronized with the clamp switches Sc1 and Sc2, whereas in Modification Examples 3-1 and 3-2, the synchronous switch S7 may perform the ON and OFF operations at timings described below.

In Modification Examples 3-1 and 3-2, the synchronous switch S7 may perform the ON and OFF operations during the dead time Δtd during which the main switches Sm1 and Sm2 and the clamp switches Sc1 and Sc2 are each set in the OFF state. In Modification Example 3-1, for example, the synchronous switch S7 may be controlled to be in the ON state with a variable pulse width during the dead time Δtd. In Modification Example 3-2, for example, the synchronous switch S7 may be controlled to be in the ON state with a fixed pulse width during the dead time Δtd. Thus, in each of Modification Examples 3-1 and 3-2, the control circuit 6C may control, through the use of the driving signal SG7, the synchronous switch S7 to be in the ON state with the variable pulse width or the fixed pulse width during the dead time Δtd.

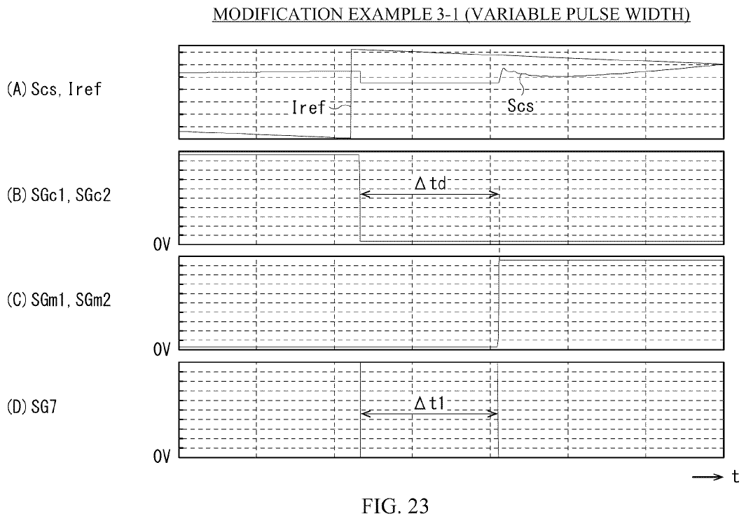

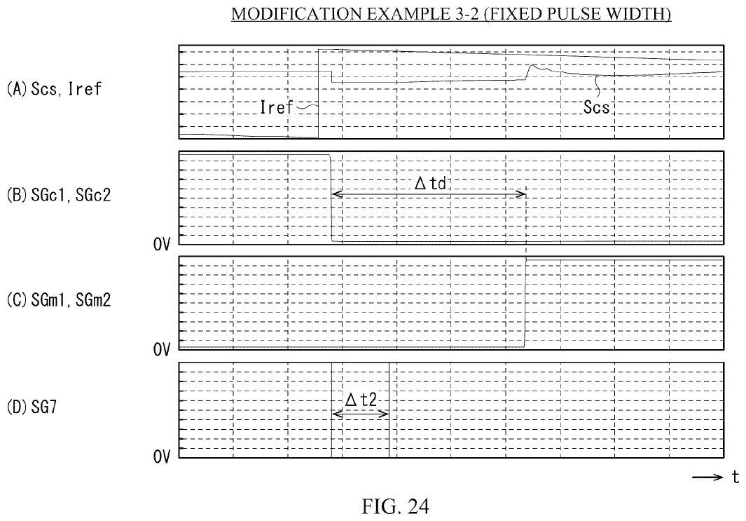

FIG. 23 is a timing chart illustrating an example operation during the current detection operation in Modification Example 3-1. FIG. 24 is a timing chart illustrating an example operation during the current detection operation in Modification Example 3-2. In each of FIGS. 23 and 24, part (A) illustrates the waveforms of the current detection signal Scs and the reference current Iref described above, part (B) illustrates the waveform of each of the driving signals SGc1 and SGc2 corresponding to the clamp switches Sc1 and Sc2, part (C) illustrates the waveform of each of the driving signals SGm1 and SGm2 corresponding to the main switches Sm1 and Sm2, and part (D) illustrates the waveform of the driving signal SG7 described above.

In Modification Example 3-1 illustrated in FIG. 23, as described above, the synchronous switch S7 may be controlled to be in the ON state with the variable pulse width, that is, with a pulse width At1 of the driving signal SG7 in part (D) of FIG. 23 set to be variable, during the dead time Δtd. In Modification Example 3-2 illustrated in FIG. 24, as described above, the synchronous switch S7 may be controlled to be in the ON state with the fixed pulse width, that is, with a pulse width At2 of the driving signal SG7 in part (D) of FIG. 24 set to be fixed, during the dead time Δtd.

In Modification Example 3 described above, the occurrence of the offset voltage on the current detection signal Scs is avoidable during the time period during which the clamp switches Sc1 and Sc2 are in the ON state; however, the offset voltage would occur on the current detection signal Scs during the dead time Δtd. In contrast, Modification Example 3-1 helps to avoid the occurrence of the offset voltage on the current detection signal Scs during the dead time Δtd. Modification Example 3-2 helps to reduce the offset voltage occurring on the current detection signal Scs to a small value during the dead time Δtd.

In Modification Example 3 described above, a time period during which it is not possible to detect an arm short circuit state (i.e., a short circuit state on the coupling lines L1 and L2) in the inverter circuit 2 will occur over a duration of, for example, several microseconds within the time period during which the clamp switches Sc1 and Sc2 are in the ON state. In Modification Example 3-2, compared to Modification Example 3, the time period during which it is not possible to detect the arm short circuit state will occur over a greatly reduced duration of, for example, 100 ns, within the dead time Δtd. In Modification Example 3-1, compared to Modification Example 3, the time period during which it is not possible to detect the arm short circuit state will occur over a reduced duration of, for example, 500 ns, within the dead time Δtd.

### Modification Examples 4-1 to 4-3

### Configuration

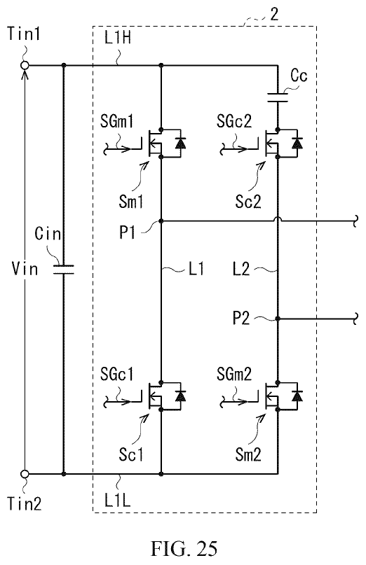

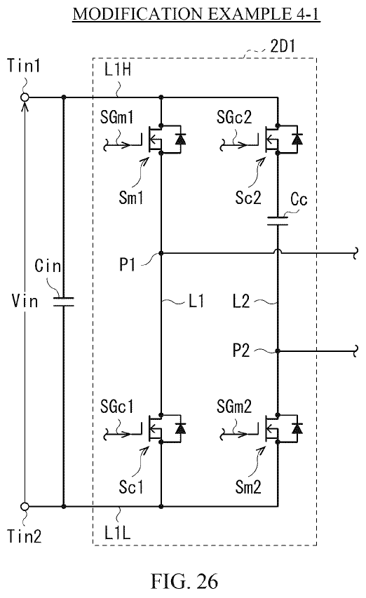

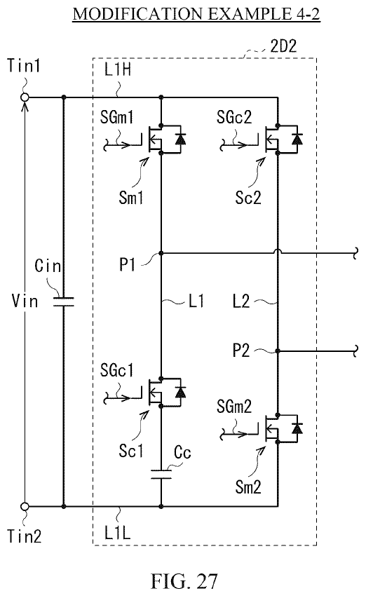

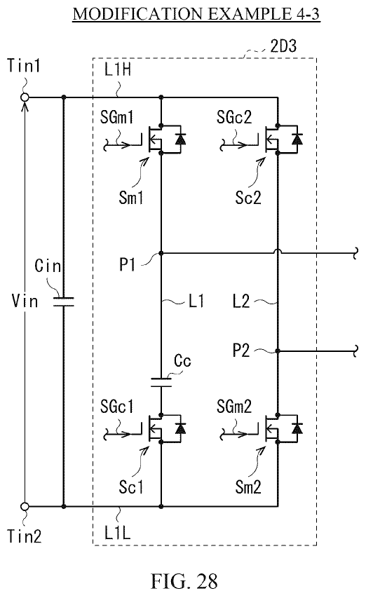

FIG. 25 is a circuit diagram illustrating a schematic configuration example of the inverter circuit 2 according to the example embodiment. FIG. 26 is a circuit diagram illustrating a schematic configuration example of an inverter circuit 2D1 according to Modification Example 4-1. FIG. 27 is a circuit diagram illustrating a schematic configuration example of an inverter circuit 2D2 according to Modification Example 4-2. FIG. 28 is a circuit diagram illustrating a schematic configuration example of an inverter circuit 2D3 according to Modification Example 4-3.

The inverter circuits 2D1, 2D2, and 2D3 according to respective Modification Examples 4-1, 4-2, and 4-3 may each correspond to the inverter circuit 2 according to the example embodiment in which the clamp capacitor Cc is disposed at a different location, with the remainder of configuration being unchanged.

For example, in the inverter circuit 2 illustrated in FIG. 25, as described above, the clamp capacitor Cc may be disposed on the first end side of the clamp switch Sc2, that is, between the clamp switch Sc2 and the primary high voltage line L1H, on the coupling line L2.

In contrast, in the inverter circuit 2D1 illustrated in FIG. 26, the clamp capacitor Cc may be disposed on a second end side of the clamp switch Sc2, that is, between the clamp switch Sc2 and the node P2, on the coupling line L2. In the inverter circuit 2D2 illustrated in FIG. 27, the clamp capacitor Cc may be disposed on a first end side of the clamp switch Sc1, that is, between the clamp switch Sc1 and the primary low voltage line L1L, on the coupling line L1. In the inverter circuit 2D3 illustrated in FIG. 28, the clamp capacitor Cc may be disposed on a second end side of the clamp switch Sc1, that is, between the clamp switch Sc1 and the node P1, on the coupling line L1.

### <Workings and Example Effects>

Basically, Modification Examples 4-1 to 4-3 with such respective configurations each help to achieve effects similar to those achievable with the example embodiment, through similar workings. In some embodiments, the location of the clamp capacitor Cc in the inverter circuit 2A of Modification Example 1 or in the inverter circuit 2B of Modification Example 2 may also be changed in a manner similar to that in any one of Modification Examples 4-1 to 4-3.

### 3. Other Modification Examples

The disclosure has been described hereinabove with reference to the example embodiment and the modification examples. However, embodiments of the disclosure are not limited thereto, and various modifications may be made.

For example, in the foregoing example embodiment and modification examples, description has been given of example configurations of the inverter circuit; however, such examples are non-limiting, and any other suitable configuration may be employed for the inverter circuit. Further, in the foregoing example embodiment and modification examples, description has been given of example configurations of the rectifying circuit; however, such examples are non-limiting, and any other suitable configuration may be employed for the rectifying circuit. Moreover, in the foregoing example embodiment and modification examples, description has been given of example configurations of the smoothing circuit; however, such examples are non-limiting, and any other suitable configuration may be employed for the smoothing circuit.

Further, in the foregoing example embodiment and modification examples, description has been given of example configurations of the transformer including the primary winding and the secondary winding; however, such examples are non-limiting, and any other suitable configuration may be employed for the transformer including the primary winding and the secondary winding.

Further, in the foregoing example embodiment and modification examples, description has been given of example operations during the switching driving to be performed by the control circuit; however, such examples are non-limiting, and any other suitable operations may be employed.

Moreover, any two or more of the configuration examples described so far may be combined and applied in a desired manner. The disclosure encompasses any possible combination of some or all of the various embodiments described herein and incorporated herein.

The effects described herein are mere examples, and effects of an embodiment of the disclosure are not limited thereto. Accordingly, any other effect may be obtained in relation to the embodiment of the disclosure.

It is possible to achieve at least the following configurations from the foregoing example embodiment and modification examples of the disclosure.

<1>

An electric power conversion apparatus including:
a pair of input terminals configured to receive an input voltage;
a pair of output terminals configured to output an output voltage;
a transformer including a primary winding and a secondary winding;
an inverter circuit disposed between the pair of input terminals and the primary winding, and including switching devices, a clamp capacitor, a first coupling line, and a second coupling line, the switching devices including a first main switch, a second main switch, a first clamp switch, and a second clamp switch, the first coupling line and the second coupling line being disposed in parallel to each other between the pair of input terminals;
a rectifying circuit disposed between the pair of output terminals and the secondary winding, and including rectifiers;
a smoothing circuit disposed between the pair of output terminals and the rectifying circuit, and including a choke coil and a capacitor; and
a control circuit configured to perform switching driving to control respective operations of the switching devices, in which
in the inverter circuit,
   the first main switch and the first clamp switch are disposed on the first coupling line in series to each other and in this order;
   the second main switch and the second clamp switch are disposed on the second coupling line in series to each other and in an order reverse to the order in which the first main switch and the first clamp switch are disposed on the first coupling line; and
   the clamp capacitor is disposed on a first end side or a second end side of the first clamp switch on the first coupling line, or disposed on a first end side or a second end side of the second clamp switch on the second coupling line.
      <2>

The electric power conversion apparatus according to <1>, in which a reset voltage of the transformer is obtainable as a resultant of subtraction of a clamp voltage from the input voltage, the clamp voltage being a voltage across the clamp capacitor.

<3>

The electric power conversion apparatus according to <1> or <2>, in which the control circuit is configured to perform the switching driving with a predetermined switching period including:
a first time period during which the first and second main switches and the first and second clamp switches are each set in an OFF state;
a second time period during which the first and second main switches are each set in an ON state and the first and second clamp switches are each set in the OFF state;
a third time period during which the first and second main switches and the first and second clamp switches are each set in the OFF state; and
a fourth time period during which the first and second main switches are each set in the OFF state and the first and second clamp switches are each set in an ON state.
   <4>

The electric power conversion apparatus according to any one of <1> to <3>, further including a resonant coil disposed on a first end side or a second end side of the primary winding.

<5>

The electric power conversion apparatus according to any one of <1> to <4>, further including a first clamp diode, a second clamp diode, a third coupling line, and a fourth coupling line, in which
the pair of input terminals include a first input terminal and a second input terminal,
the third coupling line couples a node on a first end side of the primary winding and the first input terminal to each other,
the fourth coupling line couples the node and the second input terminal to each other,
the first clamp diode is disposed on the third coupling line, and
the second clamp diode is disposed on the fourth coupling line.
   <6>

The electric power conversion apparatus according to any one of <1> to <5>, further including a current detection circuit configured to detect an input current flowing in the inverter circuit, in which
the control circuit is configured to perform the switching driving, based on a result of detection of the input current by the current detection circuit, and
the current detection circuit includes a synchronous switch controllable to perform ON and OFF operations at predetermined timings.
   <7>

The electric power conversion apparatus according to <6>, in which the control circuit is configured to control the synchronous switch to perform the ON and OFF operations at the predetermined timings synchronized with the first and second clamp switches.

<8>

The electric power conversion apparatus according to <6>, in which the control circuit is configured to control the synchronous switch to be in an ON state with a variable pulse width or a fixed pulse width during a dead time during which the first and second main switches and the first and second clamp switches are each set in an OFF state.

An electric power conversion apparatus according to at least one embodiment of the disclosure makes it possible to achieve cost reduction.

Although the technology has been described hereinabove in terms of the example embodiment and modification examples, the technology is not limited thereto. It should be appreciated that variations may be made in the described example embodiment and modification examples by those skilled in the art without departing from the scope of the disclosure as defined by the following claims. The limitations in the claims are to be interpreted broadly based on the language employed in the claims and not limited to examples described in this specification or during the prosecution of the application, and the examples are to be construed as non-exclusive. The use of the terms first, second, etc. do not denote any order or importance, but rather the terms first, second, etc. are used to distinguish one element from another. The term “substantially” and its variants are defined as being largely but not necessarily wholly what is specified as understood by one of ordinary skill in the art. The term “disposed on/provided on/formed on” and its variants as used herein refer to elements disposed directly in contact with each other or indirectly by having intervening structures therebetween. Moreover, no element or component in this disclosure is intended to be dedicated to the public regardless of whether the element or component is explicitly recited in the following claims.

What is claimed is:

1. An electric power conversion apparatus comprising:
a pair of input terminals configured to receive an input voltage;
a pair of output terminals configured to output an output voltage;
a transformer including a primary winding and a secondary winding;
an inverter circuit disposed between the pair of input terminals and the primary winding, and including switching devices, a clamp capacitor, a first coupling line, and a second coupling line, the switching devices including a first main switch, a second main switch, a first clamp switch, and a second clamp switch, the first coupling line and the second coupling line being disposed in parallel to each other between the pair of input terminals;
a rectifying circuit disposed between the pair of output terminals and the secondary winding, and including rectifiers;
a smoothing circuit disposed between the pair of output terminals and the rectifying circuit, and including a choke coil and a capacitor; and
a control circuit configured to perform switching driving to control respective operations of the switching devices, wherein
in the inverter circuit,
the first main switch and the first clamp switch are disposed on the first coupling line in series to each other and in this order;
the second main switch and the second clamp switch are disposed on the second coupling line in series to each other and in an order reverse to the order in which the first main switch and the first clamp switch are disposed on the first coupling line; and
the clamp capacitor is disposed on a first end side or a second end side of the first clamp switch on the first coupling line, or disposed on a first end side or a second end side of the second clamp switch on the second coupling line.

2. The electric power conversion apparatus according to claim 1, wherein a reset voltage of the transformer is obtainable as a resultant of subtraction of a clamp voltage from the input voltage, the clamp voltage being a voltage across the clamp capacitor.

3. The electric power conversion apparatus according to claim 1, wherein the control circuit is configured to perform the switching driving with a predetermined switching period including:
a first time period during which the first and second main switches and the first and second clamp switches are each set in an OFF state;
a second time period during which the first and second main switches are each set in an ON state and the first and second clamp switches are each set in the OFF state;
a third time period during which the first and second main switches and the first and second clamp switches are each set in the OFF state; and
a fourth time period during which the first and second main switches are each set in the OFF state and the first and second clamp switches are each set in an ON state.

4. The electric power conversion apparatus according to claim 1, further comprising a resonant coil disposed on a first end side or a second end side of the primary winding.

5. The electric power conversion apparatus according to claim 2, further comprising a resonant coil disposed on a first end side or a second end side of the primary winding.

6. The electric power conversion apparatus according to claim 3, further comprising a resonant coil disposed on a first end side or a second end side of the primary winding.

7. The electric power conversion apparatus according to claim 1, further comprising a first clamp diode, a second clamp diode, a third coupling line, and a fourth coupling line, wherein
the pair of input terminals include a first input terminal and a second input terminal,
the third coupling line couples a node on a first end side of the primary winding and the first input terminal to each other,
the fourth coupling line couples the node and the second input terminal to each other,
the first clamp diode is disposed on the third coupling line, and
the second clamp diode is disposed on the fourth coupling line.

8. The electric power conversion apparatus according to claim 2, further comprising a first clamp diode, a second clamp diode, a third coupling line, and a fourth coupling line, wherein
the pair of input terminals include a first input terminal and a second input terminal,
the third coupling line couples a node on a first end side of the primary winding and the first input terminal to each other,
the fourth coupling line couples the node and the second input terminal to each other,
the first clamp diode is disposed on the third coupling line, and
the second clamp diode is disposed on the fourth coupling line.

9. The electric power conversion apparatus according to claim 3, further comprising a first clamp diode, a second clamp diode, a third coupling line, and a fourth coupling line, wherein
the pair of input terminals include a first input terminal and a second input terminal,
the third coupling line couples a node on a first end side of the primary winding and the first input terminal to each other,
the fourth coupling line couples the node and the second input terminal to each other,
the first clamp diode is disposed on the third coupling line, and
the second clamp diode is disposed on the fourth coupling line.

10. The electric power conversion apparatus according to claim 1, further comprising a current detection circuit configured to detect an input current flowing in the inverter circuit, wherein
the control circuit is configured to perform the switching driving, based on a result of detection of the input current by the current detection circuit, and
the current detection circuit includes a synchronous switch controllable to perform ON and OFF operations at predetermined timings.

11. The electric power conversion apparatus according to claim 2, further comprising a current detection circuit configured to detect an input current flowing in the inverter circuit, wherein
the control circuit is configured to perform the switching driving, based on a result of detection of the input current by the current detection circuit, and
the current detection circuit includes a synchronous switch controllable to perform ON and OFF operations at predetermined timings.

12. The electric power conversion apparatus according to claim 3, further comprising a current detection circuit configured to detect an input current flowing in the inverter circuit, wherein
the control circuit is configured to perform the switching driving, based on a result of detection of the input current by the current detection circuit, and
the current detection circuit includes a synchronous switch controllable to perform ON and OFF operations at predetermined timings.

13. The electric power conversion apparatus according to claim 10, wherein the control circuit is configured to control the synchronous switch to perform the ON and OFF operations at the predetermined timings synchronized with the first and second clamp switches.

14. The electric power conversion apparatus according to claim 11, wherein the control circuit is configured to control the synchronous switch to perform the ON and OFF operations at the predetermined timings synchronized with the first and second clamp switches.

15. The electric power conversion apparatus according to claim 12, wherein the control circuit is configured to control the synchronous switch to perform the ON and OFF operations at the predetermined timings synchronized with the first and second clamp switches.

16. The electric power conversion apparatus according to claim 10, wherein the control circuit is configured to control the synchronous switch to be in an ON state with a variable pulse width or a fixed pulse width during a dead time during which the first and second main switches and the first and second clamp switches are each set in an OFF state.

17. The electric power conversion apparatus according to claim 11, wherein the control circuit is configured to control the synchronous switch to be in an ON state with a variable pulse width or a fixed pulse width during a dead time during which the first and second main switches and the first and second clamp switches are each set in an OFF state.

18. The electric power conversion apparatus according to claim 12, wherein the control circuit is configured to control the synchronous switch to be in an ON state with a variable pulse width or a fixed pulse width during a dead time during which the first and second main switches and the first and second clamp switches are each set in the OFF state.
